(19) United States
(12) Patent Application Publication
(10) Pub. No.: US 2026/0177652 A1
(43) Pub. Date: Jun. 25, 2026

(54) CALIBRATION METHOD AND CALIBRATION SYSTEM FOR CALIBRATING A DIRECTION FINDING DEVICE

(71) Applicant: Rohde & Schwarz GmbH & Co. KG, Muenchen (DE)

(72) Inventor: Jan LINK, Muenchen (DE)

(21) Appl. No.: 19/365,988

(22) Filed: Oct. 22, 2025

(30) Foreign Application Priority Data
Dec. 19, 2024 (EP) 24 221 833.7

(51) Int. Cl. G01S 3/02; G01S 1/04

(52) U.S. Cl. CPC G01S 3/023; G01S 1/0426; G01S 1/0428

(57) ABSTRACT

A calibration method of calibrating a direction finding (DF) device is described. The calibration method includes: positioning a mobile test device at a first position relative to the DF device to be calibrated, wherein the mobile test device comprises a GNSS circuit and a transmission circuit; obtaining, by an analysis circuit, the GNSS position of the mobile test device; generating and transmitting, by the transmission circuit, a wireless test signal; receiving, by the DF device to be calibrated, the wireless test signal; determining, by the DF device, a DF heading based on the wireless test signal; and determining, by the analysis circuit, an error angle based on the DF heading and based on the GNSS position obtained. Further, a calibration system is described.

### CROSS-REFERENCE(S) TO RELATED APPLICATION(S)

This application claims priority to European Application No. 24 221 833.7, filed on Dec. 19, 2024, the entire contents of which are disclosed herein in entirety.

### FIELD OF THE DISCLOSURE

Embodiments of the present disclosure generally relate to a calibration method of calibrating a direction finding (DF) device. Embodiments of the present disclosure further relate to a calibration system for calibrating a DF device.

### BACKGROUND

Direction finding devices that are configured to determine a DF heading of incoming radio frequency signals are employed in a plurality of different applications. Like other electronic measurement systems, it is necessary to calibrate the DF devices in order to ensure correct functionality of the DF devices. For example, a known signal source can be deployed to a predefined location, where the known signal source generates a test signal that is used to calibrate the respective DF device.

However, due to the typically required large distances of the signal source to the DF device, calibrating the DF device is rather involved and time consuming.

Thus, there is a need for a calibration method and a calibration system for calibrating a DF device that are easier to operate and require reduced time for performing the calibration.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a calibration method of calibrating a direction finding (DF) device. In an embodiment, the calibration method comprises:
positioning a mobile test device at a first position relative to the DF device to be calibrated, wherein the mobile test device comprises a GNSS circuit and a transmission circuit, wherein the GNSS circuit is configured to determine a GNSS position of the mobile test device, and wherein the transmission circuit is configured to generate and transmit a wireless test signal;
obtaining, by an analysis circuit, the GNSS position of the mobile test device;
generating and transmitting, by the transmission circuit, a wireless test signal;
receiving, by the DF device to be calibrated, the wireless test signal;
determining, by the DF device, a DF heading based on the wireless test signal; and
determining, by the analysis circuit, an error angle based on the DF heading and based on the GNSS position obtained.

The term “DF heading” is understood to denote an angle between a predefined reference direction and the direction from which the wireless test signal is received by the DF device. For example, the predefined reference direction may be north, for example true north or magnetic north.

The term “mobile test device” is understood to denote a test device that is mobile rather than stationary. In other words, the mobile test device is capable of moving between different positions, wherein the mobile test device is powered by an engine. Accordingly, test devices that have to be carried or moved to another position by a human or by another device do not fall under the definition of a “mobile test device” according to the present disclosure.

The calibration method according to embodiments of the present disclosure is based on the idea to generate the wireless test signal for calibrating the DF device by at least one mobile test device.

The mobile test device allows performance of the measurements for the calibration described above in a particularly easy and fast manner, as the position at which the wireless test signal is generated can easily be adapted by changing the position of the mobile test device. In an embodiment, this allows to perform a plurality of measurements at different positions in a particularly fast manner.

For example, an operator may control the mobile test device to move to the appropriate position(s) for performing the calibration, namely at least to the first position. Alternatively or additionally, the mobile test device may be automatically controlled to move to the appropriate position(s) for performing the calibration, namely at least to the first position.

In an embodiment, the error angle determined by the analysis circuit corresponds to an error made by the DF device during determining the DF heading. Based on the error angle determined, the DF device can be calibrated by appropriately adapting operational parameters of the DF device.

According to an aspect of the present disclosure, the mobile test device, for example, is a flying device, for example an unmanned aerial vehicle. Using a flying device, for example an UAV, allows adaption of the position(s) for performing the calibration in a particularly fast manner. Moreover, flying devices such as UAVs can be used in otherwise rather difficult environments, such as mountains or otherwise impassable terrain.

As an additional advantage, the flying device can be positioned such that a transmission path between the flying device and the DF device is free of obstacles, even if there are a plurality of obstacles on the ground. Accordingly, a maximal signal strength of the wireless test signal is ensured at the DF device. Moreover, UAVs are relatively cheap. As the steps described above and hereinafter can be performed with (modified) off-the-shelf UAVs, this reduces the costs of performing the calibration of the DF device considerably.

It is noted that such flying devices, for example UAVs, may colloquially also be called “drones”.

In an example embodiment of the present disclosure, the mobile test device is controllable by a remote control. Thus, positioning of the mobile test device is facilitated, as the mobile test device can be controlled from a distance.

In an embodiment, the remote control may be operated by a human operator. Alternatively or additionally, the remote control may be automatically operated by a control circuit, such that the mobile test device is controlled by the control circuit.

According to another aspect of the present disclosure, the GNSS position of the mobile test device, for example, is obtained by decoding signals exchanged between the mobile test device and the remote control. The data exchanged between mobile test devices such as UAVs typically comprises the GNSS position determined by the GNSS circuit of the mobile test device. Thus, by decoding the signals exchange between the mobile test device and the remote control, the GNSS position of the mobile test device can be determined.

It is noted that decoding the signals exchanged between the mobile test device and the remote control may also be called “remote decoding”.

In another embodiment of the present disclosure, the GNSS position of the mobile test device is obtained based on telemetry data of the mobile test device. The telemetry data obtained by the mobile test device typically comprises, among other data, the GNSS position obtained by the GNSS circuit of the mobile test device. Thus, the GNSS position of the mobile test device can be retrieved based on the telemetry data.

In an embodiment, the telemetry data may be transmitted by the mobile test device to a remote control controlling the mobile test device. Thus, the GNSS position of the mobile test device can be obtained by decoding a corresponding downlink signal, as described above. However, it is also conceivable that the mobile test device is configured to transmit the telemetry data to the analysis circuit directly.

A further aspect of the present disclosure provides, for example, that the error angle is determined for at least two different frequencies of the wireless test signal. It has turned out that the influence of reflections on the measurements performed can be minimized by determining the error angle for the at least two different frequencies.

In an embodiment, the at least two different frequencies may be located in at least two different frequency bands, for example in the frequency band around 2.4 GHz and in the frequency band around 5.8 GHz. However, it is to be understood that any other suitable frequencies may be used, for example in a frequency band between 0 Hz and 433 MHz, in a frequency band between 433 MHz and 2.4 GHz, in a frequency band between 2.4 GHz and 5.8 GHz, or in a frequency band above 5.8 GHz.

In an embodiment, error angles obtained at the at least two different frequencies may be averaged, thereby obtaining a frequency-averaged error angle. By averaging over the error angles obtained at the at least two different frequencies, the impact of environmental influences such as reflections as well as the influence of statistical errors is reduced. Accordingly, the DF device may be calibrated based on the frequency-averaged error angle with enhanced accuracy.

According to an aspect of the present disclosure, the error angle, for example, is determined for at least a second position of the mobile test device. In an embodiment, a heading between the DF device and the mobile test device may be different for the first position and the second position, i.e. the corresponding wireless test signals reach the DF device under different angles. Determining the error angle for a plurality of different positions of the mobile test device allows for a precise calibration of the DF device over a certain angle range.

For example, the plurality of positions of the mobile test device may be chosen such that an operational angle range of the DF device is at least partially covered, for example fully covered.

In an embodiment, the error angle may vary over different reception directions, i.e. over different angles of arrival of the wireless test signal. Determining the error angle for these different directions allows for a particularly precise calibration of the DF device over an angle range covered by the different angles of arrival.

In an embodiment, the error angles obtained at the first position and at least at the second position may be averaged, thereby obtaining a position-averaged error angle. By averaging over the error angles obtained at the at least two different positions, the impact of environmental influences such as reflections as well as the influence of statistical errors is reduced.

Accordingly, the DF device may be calibrated based on the position-averaged error angle with enhanced accuracy.

A further aspect of the present disclosure provides, for example, that measurements at different positions are performed via at least two different mobile test devices. As more than one mobile test device is provided, the number of times that the mobile test devices have to be relocated for performing the calibration measurements is reduced. In an embodiment, a calibration measurement can be performed by one of the mobile test devices while the other mobile test device(s) is (are) relocated. Thus, the time necessary for performing the calibration of the DF device is reduced substantially.

In an embodiment, the error angle is determined for a plurality of different frequencies and/or for a plurality of different positions until at least one statistical criterion is fulfilled. In general, the statistical criterion ensures that, after calibration, the DF device operates with a desired accuracy.

In an embodiment, the at least one statistical criterion may relate to an error of a DF heading determined by the DF device after calibration. More precisely, the statistical criterion may ensure that the error of the DF heading determined by the DF device after calibration is smaller than a predefined error threshold.

A further aspect of the present disclosure provides, for example, that the action of obtaining the GNSS position of the mobile test device is performed at least partially in parallel to the steps of generating and transmitting the wireless test signal, receiving the wireless test signal, and determining the DF heading based on the wireless test signal. Thus, the time necessary for performing the calibration of the DF device is reduced, as the steps of the calibration are performed at least partially in parallel, i.e. at least partially simultaneously.

In an embodiment, the action of obtaining the GNSS position of the mobile test device may be performed simultaneously with the steps of generating and transmitting the wireless test signal, receiving the wireless test signal, and determining the DF heading based on the wireless test signal

In an embodiment, the mobile test device is automatically positioned by a control circuit. In other words, the mobile test device is automatically controlled by the control circuit to move to the first position and, optionally, to further positions. Thus, the expertise required from an operator is reduced, as the operator does not have to position the mobile test device manually.

Embodiments of the present disclosure further provide a calibration system for calibrating a DF device. In an embodiment, the calibration system comprises a mobile test device and an analysis circuit. The mobile test device comprises a GNSS circuit and a transmission circuit. The calibration system is configured to perform the method according to any one of variants described above.

Regarding the further advantages and properties of the calibration system, reference is made to the explanations given above with respect to the calibration method, which also hold for the calibration system and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a calibration system for calibrating a DF device according to an embodiment of the present disclosure;

FIG. 2 schematically shows an example of a mobile test device of the calibration system of FIG. 1 in more detail; and

FIG. 3 schematically shows a representative flow chart of a calibration method according to an embodiment of the present disclosure.

### DETAILED DESCRIPTION

The detailed description set forth below in connection with the appended drawings is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

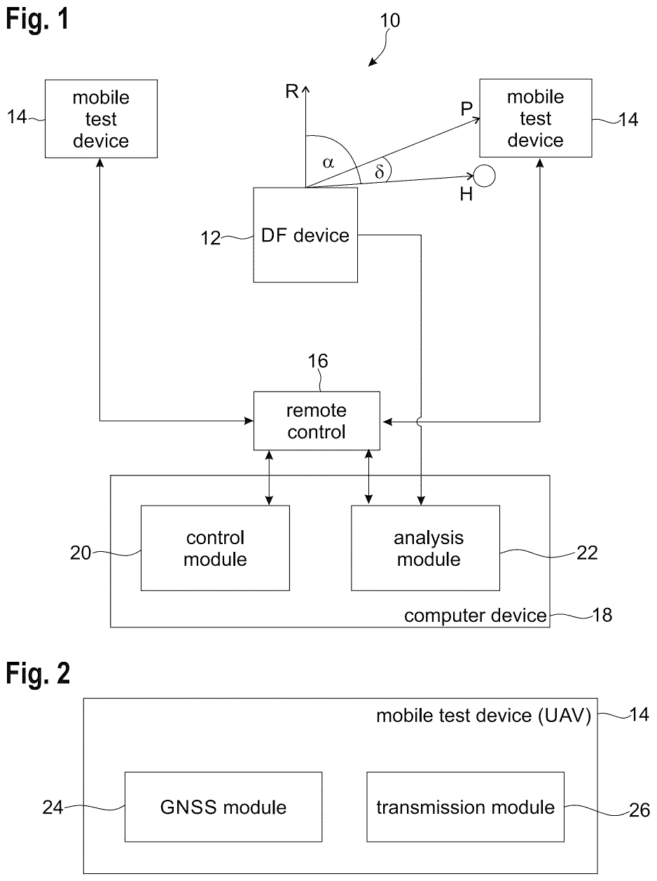

FIG. 1 schematically shows a calibration system 10 for calibrating a direction finding (DF) device 12. In general, the DF device 12 is configured to determine a DF heading of wireless radio frequency (RF) signals received by the DF device 12 relative to a predefined reference direction R. For example, the predefined reference direction R is north, for example true north or magnetic north.

In an embodiment, the DF device 12 may comprise at least one RF antenna, for example a plurality of RF antennas, as well as corresponding analysis circuitry being configured to determine the DF heading of the received RF signals. For example, the DF device 12 may be a standalone device that is used for direction finding purposes and that may be deployed permanently or temporarily. As another example, the DF device 12 may be integrated into a vehicle, such as a car, a plane, or a ship.

In the embodiment of FIG. 1, the calibration system 10 comprises at least one mobile test device 14. For example, the at least one mobile test device 14 may be a flying device such as an unmanned aerial vehicle (UAV). Without restriction of generality, the example case of the at least one mobile test device 14 being an UAV is described hereinafter. However, it is to be understood that the at least one mobile test device 14 may be established as any other suitable type of engine-powered mobile device.

It is noted that in the example embodiment shown in FIG. 1, the calibration system 10 comprises two separate mobile test devices 14. However, it is to be understood that the calibration system 10 may comprise any other number of mobile test devices 14, for example one, three, four, etc.

The calibration system 10 further comprises a remote control 16 that is connected with the at least one mobile test device 14 in a signal-transmitting manner, namely via a wireless connection. In general, the remote control 16 is configured to control the at least one mobile test device 14, as will be described in more detail below. Further, while the remote control 16 is shown to be connected to both mobile test devices 14 in the embodiment shown in FIG. 1, it is to be understood that separate remote controls may be provided for the different mobile test devices 14.

In the example embodiment shown in FIG. 1, the calibration system 10 further comprises a computer device 18 with a control circuit 20 and an analysis circuit 22. For example, the computer device 18 may be a personal computer, a laptop, a notebook, a smart phone, a measurement instrument, or any other suitable type of smart device. Moreover, it is to be understood that the control circuit 20 and/or the analysis circuit 22 may, alternatively, be integrated into the DF device 12.

In an embodiment, the control circuit 20 is connected to the remote control 16 by a suitable wireless or wired connection. The analysis circuit 22 is connected at least to the DF device 12 and, optionally, to the remote control 16 by a suitable wireless or wired connection.

FIG. 2 shows one of the mobile test devices 14 in more detail. As shown in FIG. 2, the mobile test device 14 comprises a GNSS circuit 24 that is configured to obtain or determine a GNSS position of the mobile test device 14. The mobile test device 14 also comprises a transmission circuit 26 that is configured to generate and transmit wireless test signals, as will be described in more detail below.

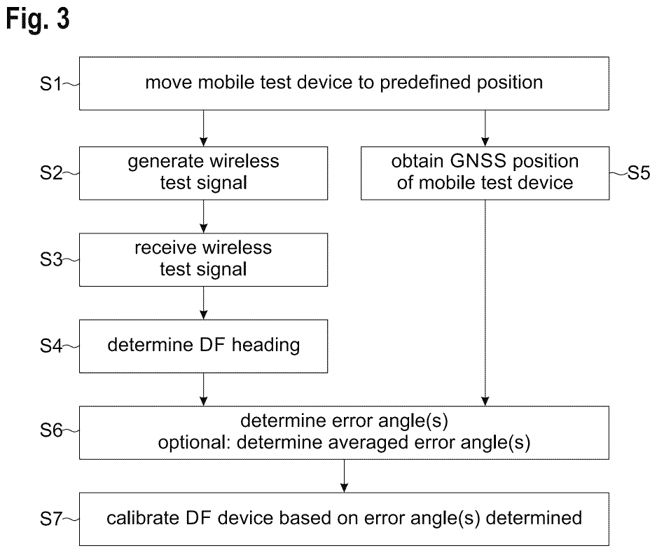

The calibration system 10 is configured to perform a calibration method of calibrating the DF device 12, an example of which is described hereinafter with reference to FIG. 3.

One of the mobile test devices 14 is positioned at a first position relative to the DF device 12 (step S1).

In an embodiment, the mobile test device 14 is controlled by the remote control 16 to move to the first position. Therein, the remote control 16 may be operated by a human operator. Alternatively, the remote control 16 may be automatically operated by the control circuit 20, for example according to a predefined test plan that comprises instructions for calibrating the DF device 12.

A wireless test signal is generated by the transmission circuit 26 of the mobile test device 14, and the wireless test signal is transmitted to the DF device 12 (step S2).

In an embodiment, the wireless test signal is generated within a predetermined frequency band, for example in a frequency band around 2.4 GHz or in a frequency band around 5.8 GHz. However, it is to be understood that any other suitable frequency may be used, for example in a frequency band between 0 Hz and 433 MHz, in a frequency band between 433 MHz and 2.4 GHz, in a frequency band between 2.4 GHz and 5.8 GHz, or in a frequency band above 5.8 GHz.

The wireless test signal is received by the DF device 12 (step S3).

A DF heading is determined by the DF device 12 based on the wireless test signal received (step S4).

As is illustrated in FIG. 1, the DF device 12 may determine a measured reception direction H from which the wireless test signal is presumably received. The determined heading corresponds to an angle α between the predetermined reference direction R and the measured reception direction H.

As is further illustrated in FIG. 1, the measured reception direction H may be different from an actual reception direction P. The DF heading determined by the DF device 12 is transmitted to the analysis circuit 22.

A GNSS position of the mobile test device 14 is obtained by the analysis circuit 22 (step S5).

As data exchanged between the mobile test device 14 and the remote control 16, for example telemetry data of the mobile test device 14, typically comprises the GNSS position of the mobile test device 14, the analysis circuit 22 may decode signals exchanged between the mobile test device and the remote control 16. In an embodiment, a downlink signal transmitted from the mobile test device 14 to the remote control 16 may be decoded by the analysis circuit 22 in order to obtain the GNSS position.

Therein, the signals exchanged between the mobile test device 14 and the remote control 16 may be intercepted by the analysis circuit 22. Alternatively or additionally, the remote control 16 may forward the signals exchanged and/or the telemetry data to the analysis circuit 22. Alternatively or additionally, the mobile test device 14 may transmit the telemetry data to the analysis circuit 22.

It is noted that step S5 may be performed at least partially in parallel to steps S2 to S4, i.e. at least partially simultaneously.

In an embodiment, step S5 may be performed simultaneously to steps S2 to S4.

An error angle δ between the DF heading determined by the DF device 12 and an actual DF heading is determined by the analysis circuit 22 based on the on the DF heading received from the DF device 12 and based on the obtained GNSS position of the mobile test device 14 (step S6).

As is illustrated in FIG. 1, the error angle δ corresponds to an angle between the measured reception direction H and the actual reception direction P.

Therein, the analysis circuit 22 may determine the actual reception direction based on the obtained GNSS position, as the GNSS position corresponds to the actual position of the mobile test device 14.

Optionally, steps S2 to S6 may be repeated for at least one further frequency of the wireless test signal, wherein the at least one further frequency is different from the previously used frequency. In other words, steps S2 to S6 are performed for at least two different frequencies.

For example, the at least two different frequencies may be located in at least two different frequency bands, for example in the frequency band around 2.4 GHz and in the frequency band around 5.8 GHz, or in any of the other frequency bands described above.

In an embodiment, the error angles obtained at the at least two different frequencies may be averaged, thereby obtaining a frequency-averaged error angle.

Alternatively or additionally to using a plurality of different frequencies, steps S1 to S6 may be repeated for at least a second position of the mobile test device 14.

Therein, the same mobile test device 14 may be moved to the second position, and the calibration measurements described above may be conducted at the second position. Alternatively, a different mobile test device 14 may be moved to the second position, and the calibration measurements described above may be conducted at the second position by the different mobile test device 14.

In an embodiment, error angles may be obtained for a plurality of different positions of the mobile test device(s) 14.

The error angles obtained at the different positions of the mobile test device(s) 14 may be averaged, thereby obtaining a position-averaged error angle.

The DF device 12 is calibrated based on the error angle(s) determined (step S7).

In an embodiment, the DF device 12 may be calibrated based on the individual error angles determined, based on the frequency-averaged error angle determined, and/or based on the position-averaged error angle determined. The DF device 12 is calibrated by adapting operational parameters of the DF device 12 such that the error angle is reduced, for example minimized.

The calibration may be performed in several iterations of steps S1 to S7 described above. For example, steps S1 to S7 described above may be repeated until a certain statistical criterion is fulfilled. For example, the statistical criterion may relate to an error of the DF heading determined by the DF device 12 after calibration. In an embodiment, the statistical criterion may relate to an error of the DF heading determined by the DF device 12 being smaller than a predefined error threshold.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be used synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the system 10, such as the DF device 12, the mobile test device(s) 14, the remote control 16, the computer device 18 etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A calibration method of calibrating a direction finding (DF) device, the calibration method comprising the steps of
positioning a mobile test device at a first position relative to the DF device to be calibrated, wherein the mobile test device comprises a GNSS circuit and a transmission circuit, wherein the GNSS circuit is configured to determine a GNSS position of the mobile test device, and wherein the transmission circuit is configured to generate and transmit a wireless test signal;
obtaining, by an analysis circuit, the GNSS position of the mobile test device;
generating and transmitting, by the transmission circuit, a wireless test signal;
receiving, by the DF device to be calibrated, the wireless test signal;
determining, by the DF device, a DF heading based on the wireless test signal; and
determining, by the analysis circuit, an error angle based on the DF heading and based on the GNSS position obtained.

2. The calibration method of claim 1, wherein the mobile test device is a flying device.

3. The calibration method of claim 2, wherein the mobile test device is an unmanned aerial vehicle.

4. The calibration method of claim 1, wherein the mobile test device is controllable by a remote control.

5. The calibration method of claim 4, wherein the GNSS position of the mobile test device is obtained by decoding signals exchanged between the mobile test device and the remote control.

6. The calibration method of claim 1, wherein the GNSS position of the mobile test device is obtained based on telemetry data of the mobile test device.

7. The calibration method of claim 1, wherein the error angle is determined for at least two different frequencies of the wireless test signal.

8. The calibration method of claim 7, wherein the error angles obtained at the at least two different frequencies are averaged, thereby obtaining a frequency-averaged error angle.

9. The calibration method of claim 1, wherein the error angle is determined for at least a second position of the mobile test device.

10. The calibration method of claim 9, wherein the error angles obtained at the first position and at least at the second position are averaged, thereby obtaining a position-averaged error angle.

11. The calibration method of claim 9, wherein measurements at different positions are performed via at least two different mobile test devices.

12. The calibration method of claim 7, wherein the error angle is determined for a plurality of different frequencies and/or for a plurality of different positions until at least one statistical criterion is fulfilled.

13. The calibration method of claim 12, wherein the at least one statistical criterion relates to an error of a DF heading determined by the DF device after calibration.

14. The calibration method of claim 1, wherein the step of obtaining the GNSS position of the mobile test device is performed at least partially in parallel to the steps of generating and transmitting the wireless test signal, receiving the wireless test signal, and determining the DF heading based on the wireless test signal.

15. The calibration method of claim 1, wherein the mobile test device is automatically positioned by a control circuit.

16. A calibration system for calibrating a DF device, the calibration system comprising a mobile test device and an analysis circuit, wherein the mobile test device comprises a GNSS circuit and a transmission circuit, and wherein the calibration system is configured to perform the method of claim 1.
